(19) United States
(12) Patent Application Publication
(10) Pub. No.: US 2026/0312276 A1
(43) Pub. Date: Oct. 8, 2026

(54) MULTIPLE SECTION WATCH WITH MULTIPLE ANTENNAS

(71) Applicant: Garmin International, Inc., Olathe, KS (US)

(72) Inventor: Yaoxuan Han, Olathe, KS (US)

(21) Appl. No.: 19/460,625

(22) Filed: Jan. 27, 2026

Related U.S. Application Data
(60) Provisional application No. 63/749,775, filed on Jan. 27, 2025.

(51) Int. Cl. H01Q 1/27; G04G 17/04; G04G 21/04

(52) U.S. Cl. CPC H01Q 1/273; G04G 17/04; G04G 21/04

(57) ABSTRACT

A wrist-worn electronic device comprises a housing, a bezel, a first antenna, and a second antenna. The housing includes a side wall, a plurality of lugs, and a bottom plate. The housing further includes a plurality of housing sections, each including at least one of, or a combination of, the side wall, the plurality of lugs, and the bottom plate. The bezel is positioned above an upper surface of the side wall and is at least partially formed from electrically conductive material. The first antenna is configured to operate at a first frequency and includes at least a portion of the bezel. The second antenna is configured to operate at a second frequency and includes at least a first one of the housing sections.

### RELATED APPLICATIONS

The current patent application is a non-provisional utility patent application which claims priority benefit, with regard to all common subject matter, under 35 U.S.C. § 119(e) of earlier-filed U.S. Provisional Application Ser. No. 63/749,775; entitled “WATCH WITH MULTI-BAND ANTENNA CONFIGURATION”; and filed Jan. 27, 2025. The Provisional Application is hereby incorporated by reference, in its entirety, into the current patent application.

### BACKGROUND

Wrist-worn electronic devices often include functionality that may be used to track a current location of a user wearing the device, along with distance traveled, velocity, and other performance metrics or data. The electronic device is typically utilized by people who are walking, jogging, running, biking, hiking, backpacking, camping, mountain climbing, geocaching, or the like. This functionality may be provided by receiving location signals from a satellite-based positioning system, such as the global navigation satellite system (GNSS). In addition, the electronic device may be equipped to provide wireless communication using standards such as long term evolution (LTE), Bluetooth™, non-terrestrial network (NTN), and the like. Each type of communication is implemented using an antenna. Positioning multiple antennas within the wrist-worn electronic device is a challenge.

### SUMMARY

Embodiments of the present technology provide a wrist-worn electronic device which includes a plurality of antennas that are formed, at least in part, from a bezel and one or more housing sections. The electronic device broadly comprises a housing, a bezel, a first antenna, and a second antenna. The housing includes a circumferential side wall, a first lug, a second lug, a third lug, a fourth lug, and a bottom plate. Each of the lugs is coupled to an outer surface of the side wall at a respective one of a plurality of angular positions. The bottom plate is coupled to a lower surface of the side wall. The side wall, the lugs, and the bottom plate are each formed from electrically conductive material. The housing further includes a plurality of housing sections, with each housing section including at least one of, or a combination of two or more of the first, second, third, and fourth lugs, the bottom plate, and the side wall or portions thereof. The bezel is positioned above an upper surface of the side wall and is at least partially formed from electrically conductive material. The first antenna is configured to operate at a first frequency and includes at least a portion of the bezel. The second antenna is configured to operate at a second frequency and includes at least a first one of the housing sections.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF DRAWINGS

Embodiments of the present technology are described in detail below with reference to the attached drawing figures, wherein:

FIG. 1 is a perspective view of a wrist-worn electronic device, constructed in accordance with various embodiments of the present technology, which utilizes a bezel and one or more housing sections to form a plurality of antennas;

FIG. 2 is a schematic block diagram illustrating electronic communication between various components of the electronic device;

FIG. 3 is a perspective exploded view of a first configuration of the electronic device in which the bezel is utilized to form at least a portion of a first antenna and a first housing section is utilized to form at least a portion of a second antenna;

FIG. 4 is a perspective exploded view of a second configuration of the electronic device in which the bezel is utilized to form at least a portion of a first antenna, a first housing section is utilized to form at least a portion of a second antenna, and a second housing section is utilized to form at least a portion of a third antenna;

FIG. 5 is a perspective exploded view of a third configuration of the electronic device in which the bezel is utilized to form at least a portion of a first antenna, a first housing section is utilized to form at least a portion of a second antenna, and a second housing section is utilized to form at least a portion of a third antenna;

FIG. 6 is a perspective exploded view of a fourth configuration of the electronic device in which the bezel is utilized to form at least a portion of a first antenna, a first housing section is utilized to form at least a portion of a second antenna, and a second housing section is utilized to form at least a portion of a third antenna;

FIG. 7 is a perspective exploded view of a fifth configuration of the electronic device in which the bezel is utilized to form at least a portion of a first antenna, a first housing section is utilized to form at least a portion of a second antenna, and a second housing section is utilized to form at least a portion of a third antenna;

FIG. 8 is a perspective exploded view of a sixth configuration of the electronic device in which the bezel is utilized to form at least a portion of a first antenna, a first housing section is utilized to form at least a portion of a second antenna, and a second housing section is utilized to form at least a portion of a third antenna;

FIG. 9 is a perspective exploded view of a seventh configuration of the electronic device in which the bezel is utilized to form at least a portion of a first antenna, a first housing section is utilized to form at least a portion of a second antenna, and a second housing section is utilized to form at least a portion of a third antenna;

FIG. 10 is a perspective exploded view of an eighth configuration of the electronic device in which the bezel is utilized to form at least a portion of a first antenna, a first housing section is utilized to form at least a portion of a second antenna, a second housing section is utilized to form at least a portion of a third antenna, and a third housing section is utilized to form at least a portion of a fourth antenna; and

FIG. 11 depicts a listing of at least a portion of the steps of an exemplary method for manufacturing a wrist-worn electronic device.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE TECHNOLOGY

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In the following description, the word “voltage” may be used to describe electric voltage, the word “current” may be used to describe electric current, and the word “power” may be used to describe electric power. In addition, the term “signal” or “electronic signal” may be used to describe an electromagnetic wave conducted through an electrically conductive medium in which a voltage and/or a current varies, or may be constant, over time.

Relational and/or directional terms, such as “above”, “below”, “up”, “upper”, “upward”, “down”, “lower”, “downward”, “top”, “bottom”, “outer”, “inner”, “left”, “right”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the present technology.

Wrist-worn electronic devices often include functionality that may be used to track a user’s current location, distance traveled, velocity, and other performance metrics or data. A wrist-worn electronic device is typically utilized by people who are walking, jogging, running, biking, hiking, backpacking, camping, mountain climbing, geocaching, or the like. This functionality may be provided by receiving location signals from a satellite-based positioning system, such as the global navigation satellite system (GNSS). Location determining accuracy may be improved by receiving GNSS signals output on two frequency bands, such as the L1 and L5 bands for the global positioning system (GPS). In addition, such devices may communicate wirelessly with other electronic devices, systems, or networks to monitor the user’s activities and their performance during the activities, upload and download data, receive messages and information, and so forth. The communication protocols utilized to transmit and receive information may include Bluetooth, Wi-Fi, or telecommunications, such as cellular, signaling protocols. Furthermore, such devices may communicate wirelessly using non-terrestrial network (NTN) communication when the device is in a remote area. Each type of communication may require transmission and/or reception of wireless signals at a particular frequency or frequency band, which in turn requires a separate antenna. Constructing an electronic device that is worn on the user’s wrist and is able to accommodate multiple antennas presents a challenge for the antenna design.

Embodiments of the present technology provide a wrist-worn electronic device which includes a plurality of antennas that are formed, at least in part, from a bezel and one or more housing sections. The electronic device also includes a display and a housing. The bezel generally forms a ring that surrounds the display. The housing includes a side wall, a plurality of lugs, and a bottom plate. The side wall is circumferential and is attached to the lugs and the bottom plate. The housing sections are formed by, or include, at least one of, or a combination of two or more of, the side wall, the lugs, and the bottom plate or portions thereof. The bezel and each of the housing sections may be formed from electrically conductive and electromagnetically radiating material. The bezel and the housing sections may be utilized to form up to four (4) antennas. As an example, a first antenna may include at least the bezel or a portion thereof. A second antenna may include at least a first housing section. A third antenna may include at least a second housing section. And, a fourth antenna may include at least a third housing section.

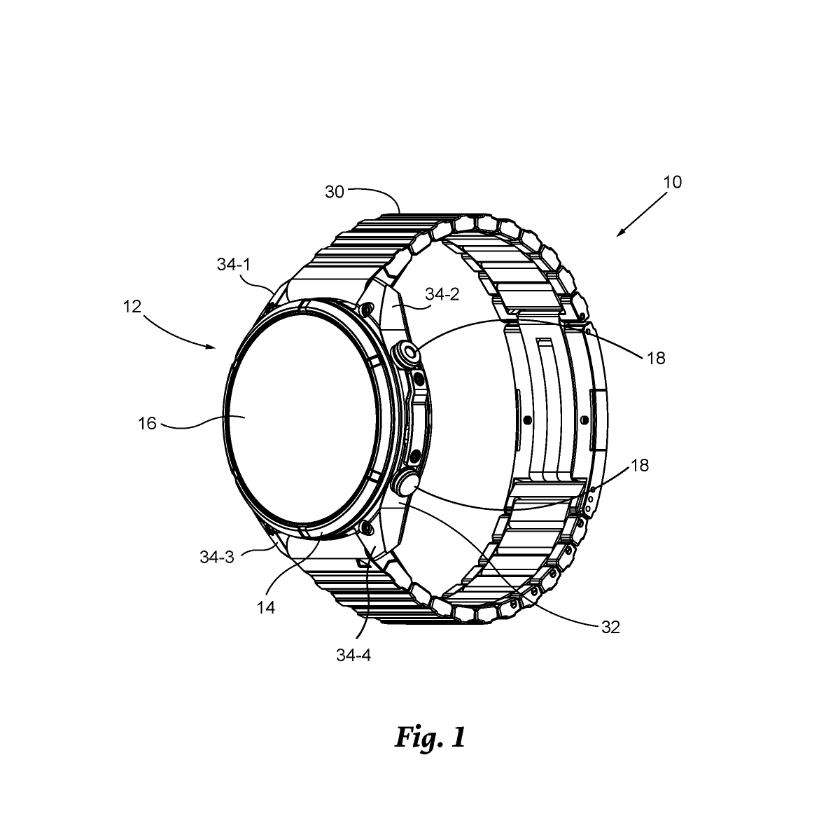

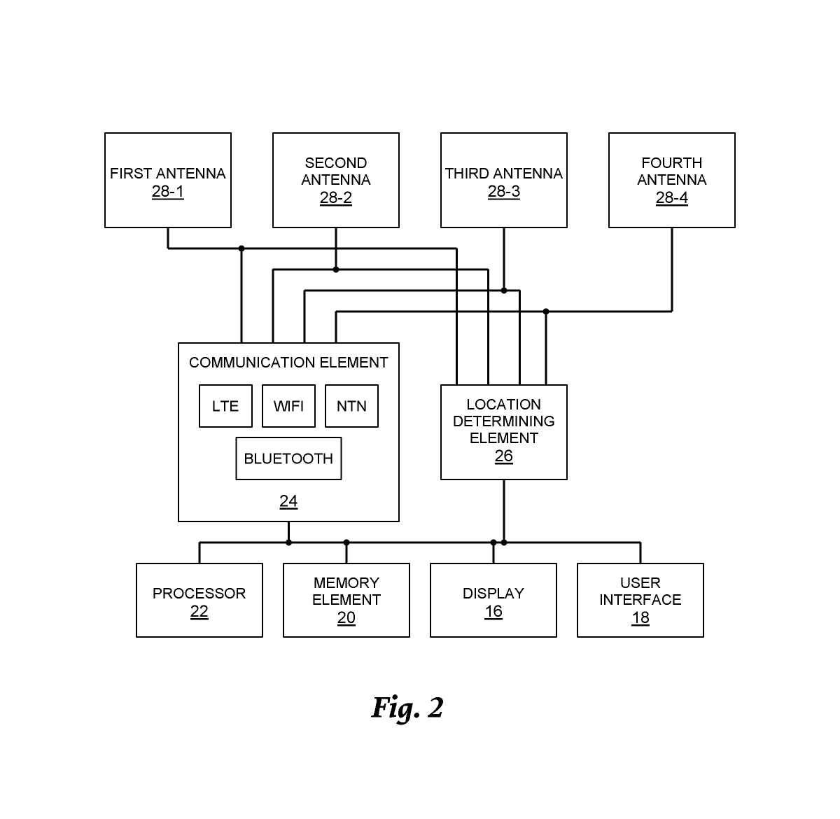

Embodiments of the technology will now be described in more detail with reference to the drawing figures. Referring initially to FIGS. 1 and 2, a wrist-worn electronic device 10 is illustrated. The electronic device 10 broadly comprises a housing 12, a bezel 14, a display 16, a user interface 18, a memory element 20, a processor 22, a communication element 24, a location determining element 26, a first antenna 28-1, a second antenna 28-2, a third antenna 28-3, and a fourth antenna 28-4. The electronic device 10 may also include a wrist band 30, a strap, or other attachment mechanisms. In addition, communication between various electronic components of the electronic device 10 is illustrated schematically in FIG. 2.

The housing 12 generally houses or retains other components of the electronic device 10 and may include or be coupled to the wrist band 30. The housing 12 may include at least one side wall 32, a plurality of lugs 34, and a bottom plate 36. In exemplary embodiments that are shown in the figures, the housing 12 includes a single side wall 32, with inner and outer surfaces, an upper surface or edge, and a lower surface or edge. The side wall 32 has a circular or ring shape which generally forms a hollow cylinder. In other embodiments, the side wall 32 may have an oval or elliptical shape. In still other embodiments, the housing 12 may include a plurality of side walls which form one of a plurality of geometric or polygonal shapes, such as triangular, square or rectangular, hexagonal, octagonal, and so forth. In exemplary embodiments, the side wall 32 further includes one or more through holes extending from the inner surface to the outer surface. Components of the user interface 18 may be positioned in the through holes.

The lugs 34 include a first lug 34-1, a second lug 34-2, a third lug 34-3, and a fourth lug 34-4. Each lug 34 is attached, connected, or coupled to the outer surface of the side wall 32 at a respective one of a plurality of angular positions generally related to the hourly positions on a clock face, which are positioned 30 degrees apart from one another. For example, the first lug 34-1 may be coupled to the side wall 32 at the 11 o’clock position, the second lug 34-2 may be coupled to the side wall 32 at the 1 o’clock position, the third lug 34-3 may be coupled to the side wall 32 at the 7 o’clock position, and the fourth lug 34-4 may be coupled to the side wall 32 at the 5 o’clock position. The lugs 34 generally allow for the wrist band 30 to connect to the housing 12. Specifically, the first lug 34-1 and the second lug 34-2, in combination, retain a first removable pin to which a first end of the wrist band 30 attaches, and the third lug 34-3 and the fourth lug 34-4, in combination, retain a second removable pin to which a second end of the wrist band 30 attaches.

The bottom plate 36 is positioned beneath, and attached to, the lower surface of the side wall 32. The bottom plate 36 generally conforms to the shape of the side wall 32. Thus, exemplary embodiments of the bottom plate 36 have a circular or disc shape. The bottom plate 36 includes a lower, outer surface that contacts the user’s wrist while the user is wearing the electronic device 10.

The lugs 34 and the bottom plate 36 are each coupled or attached to the side wall 32 to form a monolithic or unibody housing 12. In addition, the side wall 32, the lugs 34, and the bottom plate 36 are each at least partially formed from electrically conductive materials, such as metals and/or metal alloys, which are also electromagnetically radiating.

The housing 12 further includes a plurality of housing sections 38. Each housing section 38 includes at least one of, or a combination of two or more of, the side wall 32, the first lug 34-1, the second lug 34-2, the third lug 34-3, the fourth lug 34-4, and the bottom plate 36 or portions thereof. For example, in one configuration, a first housing section 38-1 may include the first lug 34-1 and a first portion of the side wall 32, while a second housing section 38-2 may include the second lug 34-2, the third lug 34-3, the fourth lug 34-4, a second portion of the side wall 32, and the bottom plate 36. In another configuration, the first housing section 38-1 may include the first lug 34-1, the second lug 34-2, and a third portion of the side wall 32, while the second housing section 38-2 may include the third lug 34-3, the fourth lug 34-4, a fourth portion of the side wall 32, and the bottom plate 36. Each housing section 38 may be electrically isolated from the other housing sections 38, and joined to the other housing sections 38 with a non-conductive, electrically insulating material.

In various embodiments, the selection and definition of the housing sections 38—including the particular lugs 34, portions of the side wall 32, the bottom plate 36, and, where applicable, the bezel 14—may be based on desired antenna performance characteristics. More specifically, the size, shape, and electrical length of each housing section 38 that forms all or part of an antenna may be chosen to correspond to a target wavelength, or a fraction thereof, of the wireless signals to be transmitted and/or received by the corresponding antenna 28. In this manner, the housing sections 38 may function as radiating elements having dimensions selected to support resonance at one or more desired operating frequencies.

Additionally, the allocation of structural components to a given housing section 38 may be selected to achieve desired antenna gain, radiation efficiency, and radiation pattern characteristics. For example, combining multiple lugs 34 with a portion of the side wall 32 and/or the bottom plate 36 into a single housing section 38 may increase the effective radiating length or surface area of the antenna, while separating other components into different housing sections 38 may reduce coupling or interference between antennas operating at different frequencies. Accordingly, the partitioning of the housing 12 into the housing sections 38 may be tailored to support multi-band operation and to optimize antenna performance for specific wireless communication protocols or positioning systems.

The bezel 14 generally frames the display 16 and is positioned above the upper surface of the side wall 32. In various embodiments, the bezel 14 may be coupled to an electrically insulating ring which is coupled to the upper surface of the side wall 32, such that the bezel 14 is not electrically connected to the side wall 32. The bezel 14 is generally annular shaped with a circular aspect and has a central opening through which the display 16 is visible and may, itself, retain a lens or other components that cover the display 16. The bezel 14 is formed from electrically conductive materials, such as metals and/or metal alloys, which are also electromagnetically radiating.

The display 16 may include video devices of the following types: light-emitting diode (LED), organic LED (OLED), Light Emitting Polymer (LEP) or Polymer LED (PLED), liquid crystal display (LCD), thin film transistor (TFT) LCD, or the like, or combinations thereof. The display 16 may include a screen on which information is presented, with the screen possessing any one of a variety of shapes, such as a square or a rectangular aspect ratio that may be viewed in either a landscape or a portrait mode. In some embodiments, the display 16 may further include a lens overlying the viewing area, which may enhance the visibility of the information shown on the display 16. In various embodiments, the display 16 may also include a touch screen occupying the entire screen or a portion thereof so that the display 16 functions as part of the user interface 18. The touch screen may allow the user to interact with the electronic device 10 by physically touching, swiping, or gesturing on areas of the screen. The display 16 may be in electronic communication with the memory element 20 and the processor 22 and may receive data or information therefrom that is to be shown on the display 16.

The user interface 18 generally allows the user to directly interact with the electronic device 10 and may include pushbuttons, rotary knobs, or the like. In the exemplary embodiment of FIG. 1, the housing 12 may include one or more pushbuttons and/or rotary knobs located in the through holes of the side wall 32 that function as at least a portion of the user interface 18. The user interface 18 may allow the user to scroll through menus or change screens in order to control the function or operation of the electronic device 10.

The memory element 20 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, optical disks, flash memory, thumb drives, universal serial bus (USB) drives, solid state memory, solid state drives (SSDs), or the like, or combinations thereof. In some embodiments, the memory element 20 may be embedded in, or integrated in the same package as, the processor 22. The memory element 20 may include, constitute, or embody, a non-transitory “computer-readable medium”. The memory element 20 may store the instructions, code, code statements, code segments, software, firmware, programs, applications, apps, services, daemons, or the like that are executed by the processor 22. The memory element 20 is in electronic communication with the processor 22 and may also store data that is received by the processor 22 or the device in which the processor 22 is implemented. The processor 22 may further store data or intermediate results generated during processing, calculations, and/or computations as well as data or final results after processing, calculations, and/or computations. In addition, the memory element 20 may store settings, lookup tables, text data, documents from word processing software, spreadsheet software and other software applications, sampled audio sound files, photograph or other image data, movie data, databases, and the like.

The processor 22 may comprise one or more processors that include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor 22 may further include system on a chip (SoC) architectures. The processor 22 may generally execute, process, or run algorithms, instructions, code, code segments, code statements, software, firmware, programs, applications, apps, processes, services, daemons, or the like. The processor 22 may also include hardware components such as registers, finite-state machines, sequential and combinational logic, configurable logic blocks, and other electronic circuits that can perform the functions necessary for the operation of the present technology. In certain embodiments, the processor 22 may include multiple computational components and functional blocks that are packaged separately but function as a single unit. In some embodiments, the processor 22 may further include multiprocessor architectures, parallel processor architectures, processor clusters, and the like, which provide high performance computing. The processor 22 may be in electronic communication with the other electronic components of the electronic device 10 through serial or parallel links that include universal busses, address busses, data busses, control lines, and the like. In addition, the processor 22 may include analog to digital converters (ADCs) to convert analog electronic signals to digital data values in binary form (such as by sampling), or streams of digital data values, and/or digital to analog converters (DACs) to convert digital data values, or streams of digital data values, to analog electronic signals.

The processor 22 is operable, configured, programmed, and/or trained to perform the functions, operations, processes, methods, and/or algorithms of the electronic device 10 by utilizing hardware, software, firmware, or combinations thereof. Other components, such as the communication element 24 and the memory element 20 may be utilized as well.

The communication element 24 generally allows the electronic device 10 to communicate with other computing devices, external systems, computing networks, telecommunication networks, the Internet, and the like. The communication element 24 may include signal and/or data transmitting and receiving circuits, such as amplifiers, filters, mixers, oscillators, digital signal processors (DSPs), and the like. The communication element 24 may establish communication wirelessly by utilizing radio frequency (RF) signals and/or data that comply with communication standards such as cellular 2G, 3G, 4G, Voice over Internet Protocol (VoIP), or 5G, Institute of Electrical and Electronics Engineers (IEEE) 802.11 standard such as WiFi, IEEE 802.16 standard such as WiMAX, Bluetooth™, or combinations thereof. Wireless signals that utilize WiFi and Bluetooth™ protocols may have a frequency of 2.4 gigahertz (GHz). The communication element 24 may also utilize communication standards such as ANT, ANT+, Bluetooth™ low energy (BLE), the industrial, scientific, and medical (ISM) band at 2.4 GHz, or the like. In addition, the communication element 24 may utilize standards which provide communication with long-term evolution (LTE) communication systems, including terrestrial wireless broadband communication networks and is a part of, or an extension of, the fourth generation (4G) telecommunication standard. The LTE frequency bands include various B bands (B1, B2, B3, B4, B8, B12, B20, B28, etc.) utilized in North America, Central America, South America, Europe, the Middle East, Africa, Asia, Australia, and New Zealand. Furthermore, the communication element 24 may utilize standards which provide communication with non-terrestrial network (NTN) systems including spaceborne platforms, such as low-earth orbit (LEO) satellites, medium-earth orbit (MEO) satellites, geosynchronous-earth orbit (GEO) satellites, etc., airborne platforms, such as airplanes, balloons, airships, etc., and air to ground networks such as terrestrial tower antennas to communicate with the spaceborne and airborne platforms as well as terrestrial networks. The NTN frequency bands include the NTN (n255) L band and the NTN (n256) S band, which range from approximately 700MHz to approximately 2200 MHz. The communication element 24 may be in electronic communication with the memory element 20 and the processor 22. In addition, the communication element 24 may be in electronic communication with the first antenna 28-1, the second antenna 28-2, the third antenna 28-3, and the fourth antenna 28-4. That is, the communication element 24 may communicate electronic signals, for wireless transmitting and receiving, to and/or from each of the antennas 28.

The location determining element 26 generally determines a current geolocation of the electronic device 10 and may receive and process RF wireless signals, such as wireless location signals, output by satellites of a multi-constellation GNSS such as the global positioning system (GPS) utilized in the United States, the GLONASS system utilized in Russia, the Galileo system utilized in Europe, or the like. The location determining element 26 may include satellite navigation receivers, processors, controllers, other computing devices, or combinations thereof, and memory. The location determining element 26 receives and processes one or more location electronic signals from the first antenna 28-1, the second antenna 28-2, the third antenna 28-3, and the fourth antenna 28-4, which correspond to, and are derived from, one or more location wireless signals output by GNSS satellites. The location wireless signal includes data and information that the location determining element 26 is able to utilize to determine a current geolocation of the electronic device 10. An exemplary location wireless signal is output by GPS satellites and has a frequency in the GPS L1 band, which has a center frequency of approximately 1575 MHz. The location wireless signal may also include the GPS L5 signal, which has a center frequency of approximately 1175 MHz. The location determining element 26 can receive and utilize location signals output by GPS satellites in the GPS L1 band and/or GPS L5 band. With the data and information from location signals output by GPS satellites on both the GPS L1 band and the GPS L5 band, the location determining element 26 of the present technology is capable of determining the current geolocation of the electronic device 10 with greater accuracy than conventional devices that may only utilize location signals output by GPS satellites on the GPS L1 band alone. The location determining element 26 may communicate the determined current geolocation to the processor 22, store the determined current geolocation in the memory element 20, or both. Although the location determining element 26 of the present technology utilizes data and information from location signals output on both GPS L1 and L5 bands, it is within the scope of the present technology for the location determining element 26 to utilize data and information from two or more bands from other GNSS constellations, such as GLONASS or Galileo.

Each of the antennas 28 converts wireless RF electromagnetic radiation (a wireless signal) in a characteristic mode at one or more frequencies, i.e., one or more resonant frequencies, into a corresponding electronic signal and converts an electronic signal into a corresponding wireless signal. Each of the antennas 28 may operate, i.e., receive and/or transmit, in a range of characteristic modes or resonant frequencies from approximately 700 MHz to approximately 2.4 GHz. Accordingly, any of the antennas 28 may be utilized to receive and/or transmit GPS L1 band and/or L5 band wireless signals, Bluetooth™ wireless signals, Wi-Fi wireless signals, LTE wireless signals, NTN wireless signals, and so forth. The resonant frequency, or frequency of operation, may vary according to, or depend on, a length of the radiating portion of the antenna 28, which typically corresponds to a wavelength, or a portion thereof, such as a quarter wavelength, or a half wavelength, of the wireless signals transmitted and/or received by the antenna 28.

Each of the antennas 28 may be implemented as an inverted-F antenna, a patch antenna, a loop antenna, a slot antenna, or the like and may be formed at least in part by, or may include, one of the housing sections 38 or the bezel 14. In various embodiments, each of the antennas 28 may further be formed by or include a printed circuit board (not shown in the figures) and electrical connectors which connect the printed circuit board to the bezel 14, the side wall 32, the bottom plate 36, or combinations thereof. In addition, each antenna 28 is in electronic communication with the communication element 24, the location determining element 26, or both such that electronic signals are conducted between the listed components.

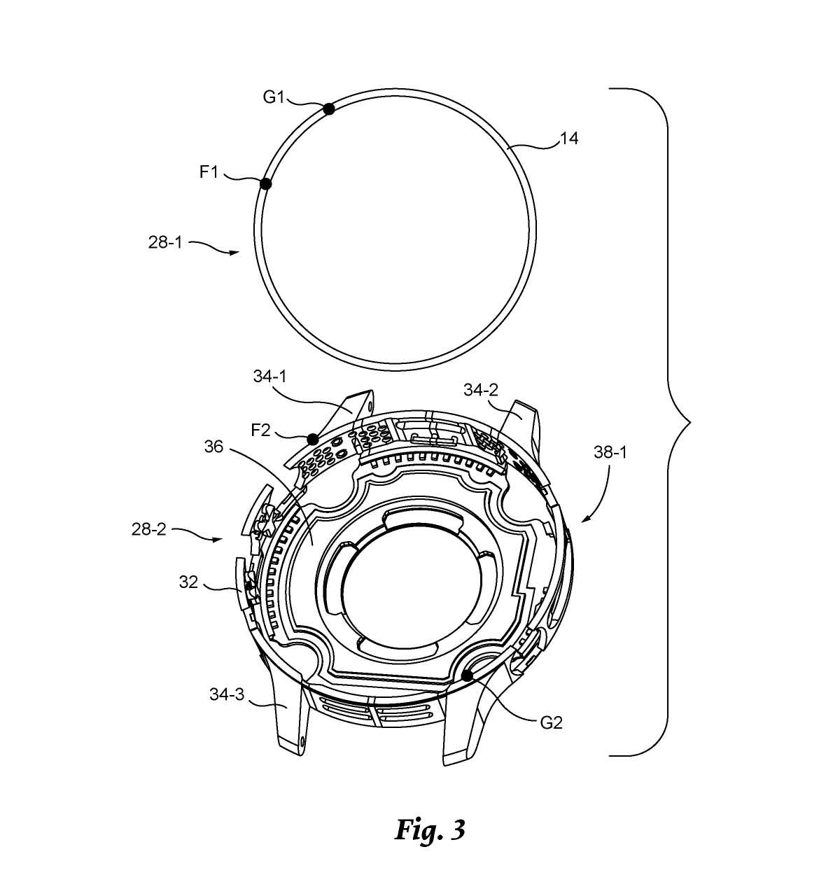

Referring to FIG. 3, in a first configuration or embodiment, the electronic device 10 includes the first antenna 28-1 and the second antenna 28-2. The first antenna 28-1 is formed at least in part by, or includes, the bezel 14. In some embodiments, the entire bezel 14 may be utilized, while in other embodiments, a portion of the circumference of the bezel 14 may be utilized. Exemplary implementations of utilizing the bezel 14 to form any of the antennas 28 are described in more detail in U.S. Application Nos. 19/278,514 (“WATCH HOUSING HAVING A RECEIVING STRUCTURE AND OUTER STRUCTURE ELEMENTS”) and 19/202,371 (“WATCH WITH ADJUSTABLE-LENGTH BIPLANAR ANTENNA CONFIGURATION”), each of which is incorporated by reference, in its entirety, into the current patent application, except where inconsistent with the teachings of the current patent application. The first antenna 28-1 may also include a signal feed point F1 positioned on the bezel 14 between approximately 9 o’clock and approximately 10 o'clock and a ground point G1 positioned on the bezel 14 at approximately 11 o'clock.

The signal feed points, such as signal feed point F1, are locations on components of the housing 12 that are electrically connected to the communication element 24 and/or the location determining element 26. The ground points, such as ground point G1, are locations on components of the housing 12 that are electrically connected to electrical ground. The signal feed points and ground points illustrated and labeled in the figures are provided for explanatory purposes for each illustrated embodiment, and the associated reference numerals (e.g., F1–F4 and G1–G4) may be embodiment-specific; accordingly, a reference numeral used for a feed point or a ground point in one figure or embodiment may identify a different feed point or ground point location in another figure or embodiment.

The second antenna 28-2 is formed at least in part by, or includes, a first housing section 38-1, which includes the side wall 32, the four lugs 34, and the bottom plate 36. The second antenna 28-2 further includes a signal feed point F2 positioned on the upper surface of the side wall 32 at approximately 11 o'clock. The second antenna 28-2 further includes a ground point G2 positioned on the upper surface of the side wall 32 at approximately 5 o'clock.

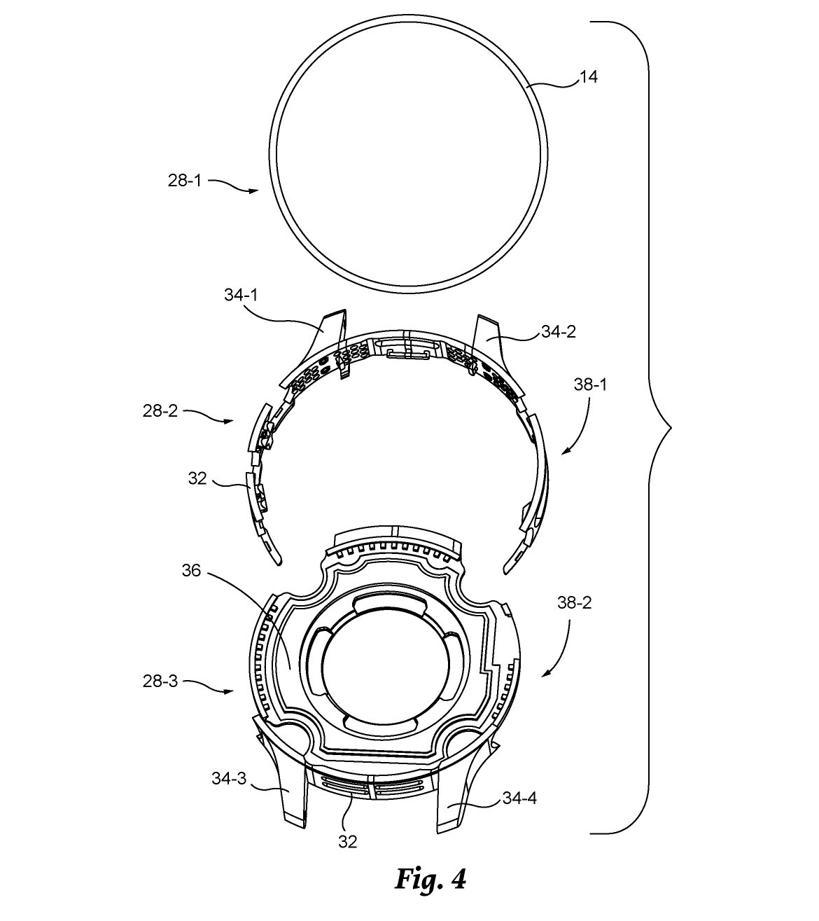

FIGS. 4-10 depict the various housing sections 38 being physically separated from one another. The physical separation is presented to more easily identify the different housing sections 38. In reality, the housing sections 38 are joined together, as described in more detail below.

Referring to FIG. 4, in a second configuration or embodiment, the electronic device 10 includes the first antenna 28-1, the second antenna 28-2, and the third antenna 28-3. The first antenna 28-1 is formed at least in part by, or includes, the bezel 14. In some embodiments, the entire bezel 14 may be utilized, while in other embodiments, a portion of the circumference of the bezel 14 may be utilized. The second antenna 28-2 is formed at least in part by, or includes, a first housing section 38-1, which includes the first lug 34-1, the second lug 34-2, and a first portion of the side wall 32 extending from approximately 8 o’clock clockwise to approximately 4 o'clock. The third antenna 28-3 is formed at least in part by, or includes, a second housing section 38-2, which includes the third lug 34-3, the fourth lug 34-4, a second portion of the side wall 32 extending from approximately 8 o’clock counterclockwise to approximately 4 o'clock, and the bottom plate 36.

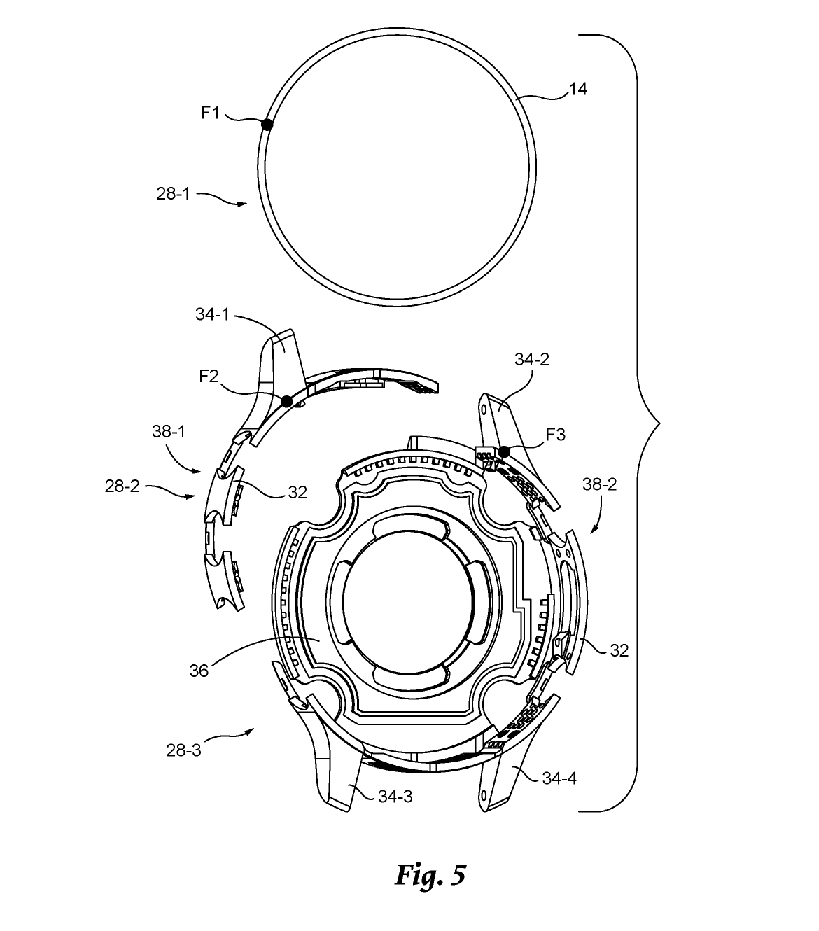

Referring to FIG. 5, in a third configuration or embodiment, the electronic device 10 includes the first antenna 28-1, the second antenna 28-2, and the third antenna 28-3. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock.

The second antenna 28-2 is formed at least in part by, or includes, a first housing section 38-1, which includes the first lug 34-1 and a first portion of the side wall 32 extending from approximately 8 o’clock clockwise to approximately 1 o'clock. The second antenna 28-2 may also include a signal feed point F2 positioned on the upper surface of the side wall 32 at approximately 11 o’clock.

The third antenna 28-3 is formed at least in part by, or includes, a second housing section 38-2, which includes the second lug 34-2, the third lug 34-3, the fourth lug 34-4, a second portion of the side wall 32 extending from approximately 8 o’clock counterclockwise to approximately1 o'clock, and the bottom plate 36. The third antenna 28-3 may also include a signal feed point F3 positioned on the upper surface of the side wall 32 at approximately 1 o’clock.

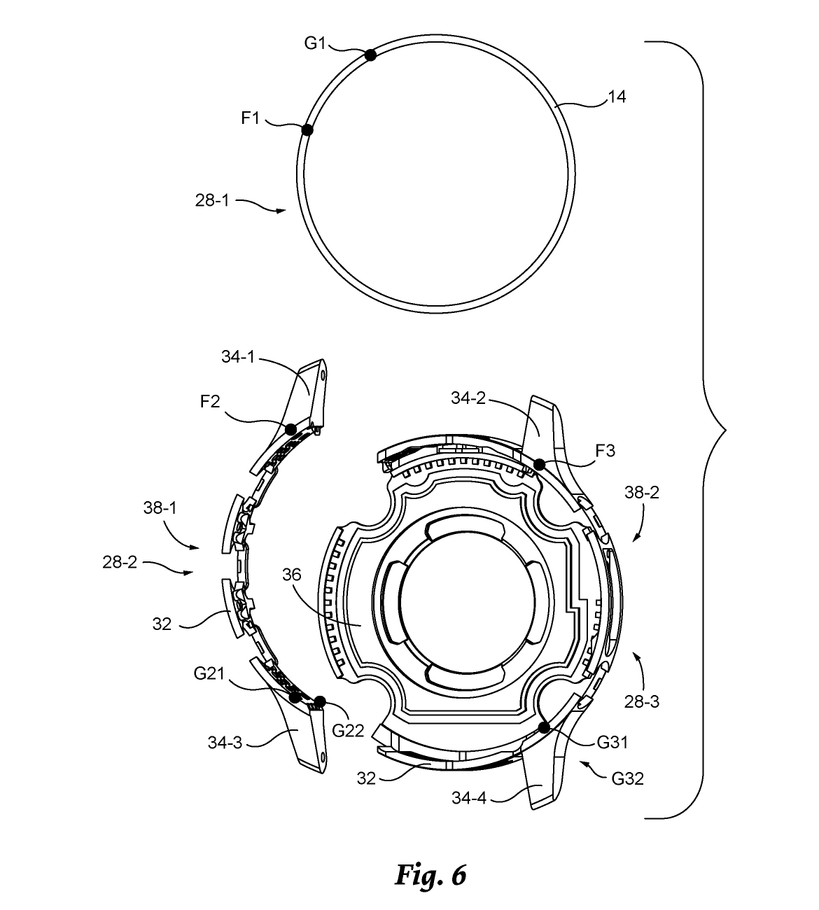

Referring to FIG. 6, in a fourth configuration or embodiment, the electronic device 10 includes the first antenna 28-1, the second antenna 28-2, and the third antenna 28-3. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock and a ground point G1 positioned on the bezel 14 at approximately 11 o'clock.

The second antenna 28-2 is formed at least in part by, or includes, a first housing section 38-1, which includes the first lug 34-1, the third lug 34-3, and a first portion of the side wall 32 extending from approximately 7 o’clock clockwise to approximately 11 o'clock. The second antenna 28-2 may also include a signal feed point F2 positioned on the upper surface of the side wall 32 at approximately 11 o’clock. The second antenna 28-2 may further include a first ground point G21 positioned on the upper surface of the side wall 32 at approximately 7 o’clock and a second ground point G22 positioned on the lower surface of the side wall 32 at approximately 7 o’clock.

The third antenna 28-3 is formed at least in part by, or includes, a second housing section 38-2, which includes the second lug 34-2, the fourth lug 34-4, a second portion of the side wall 32 extending from approximately 7 o’clock counterclockwise to approximately 11 o'clock, and the bottom plate 36. The third antenna 28-3 may also include a signal feed point F3 positioned on the upper surface of the side wall 32 at approximately 1 o’clock. The third antenna 28-3 may further include a first ground point G31 positioned on the upper surface of the side wall 32 at approximately 5 o’clock and a second ground point G32 positioned on the lower surface of the side wall 32 at approximately 5 o’clock.

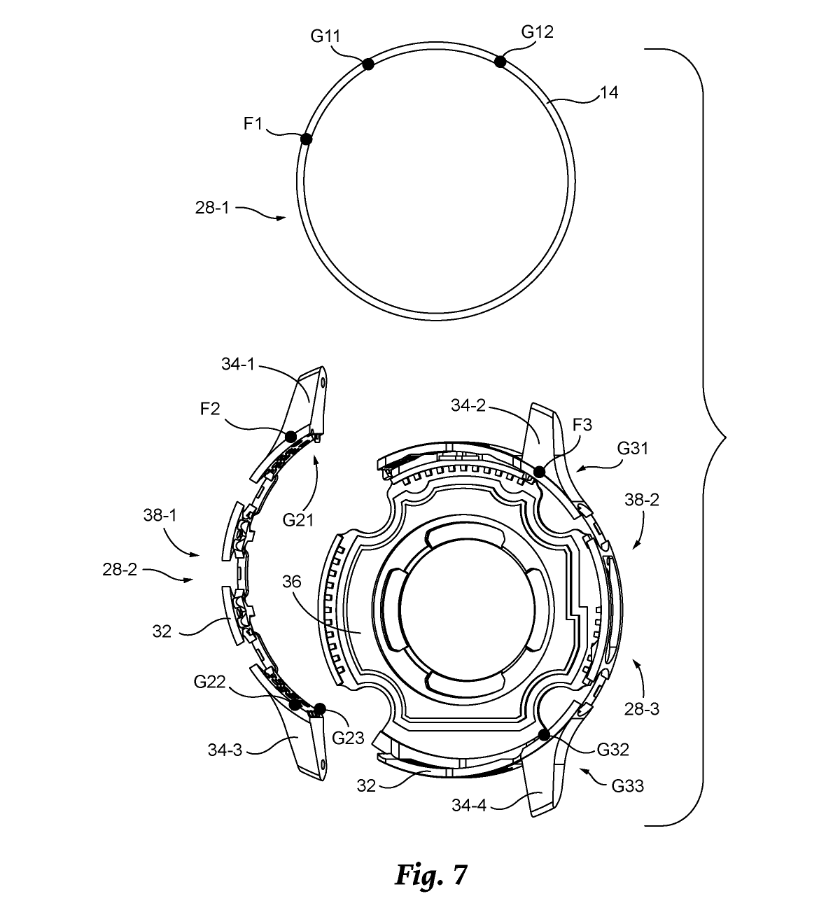

Referring to FIG. 7, in a fifth configuration or embodiment, the electronic device 10 includes the first antenna 28-1, the second antenna 28-2, and the third antenna 28-3. The fifth configuration of the antennas 28 is very similar to the fourth configuration, the difference being that the fifth configuration includes additional ground points. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock, a first ground point G11 positioned on the bezel 14 at approximately 11 o'clock, and a second ground point G12 positioned on the bezel 14 at approximately 1 o’clock.

The second antenna 28-2 is formed at least in part by, or includes, a first housing section 38-1, which includes the first lug 34-1, the third lug 34-3, and a first portion of the side wall 32 extending from approximately 7 o’clock clockwise to approximately 11 o'clock. The second antenna 28-2 may also include a signal feed point F2 positioned on the upper surface of the side wall 32 at approximately 11 o’clock. The second antenna 28-2 may further include a first ground point G21 positioned on the lower surface of the side wall 32 at approximately 11 o’clock, a second ground point G22 positioned on the upper surface of the side wall 32 at approximately 7 o’clock, and a third ground point G23 positioned on the lower surface of the side wall 32 at approximately 7 o’clock.

The third antenna 28-3 is formed at least in part by, or includes, a second housing section 38-2, which includes the second lug 34-2, the fourth lug 34-4, a second portion of the side wall 32 extending from approximately 7 o’clock counterclockwise to approximately 11 o'clock, and the bottom plate 36. The third antenna 28-3 may also include a signal feed point F3 positioned on the upper surface of the side wall 32 at approximately 1 o’clock. The third antenna 28-3 may further include a first ground point G31 positioned on the upper surface of the side wall 32 at approximately 1 o’clock, a second ground point G32 positioned on the upper surface of the side wall 32 at approximately 5 o’clock, and a third ground point G33 positioned on the lower surface of the side wall 32 at approximately 5 o’clock.

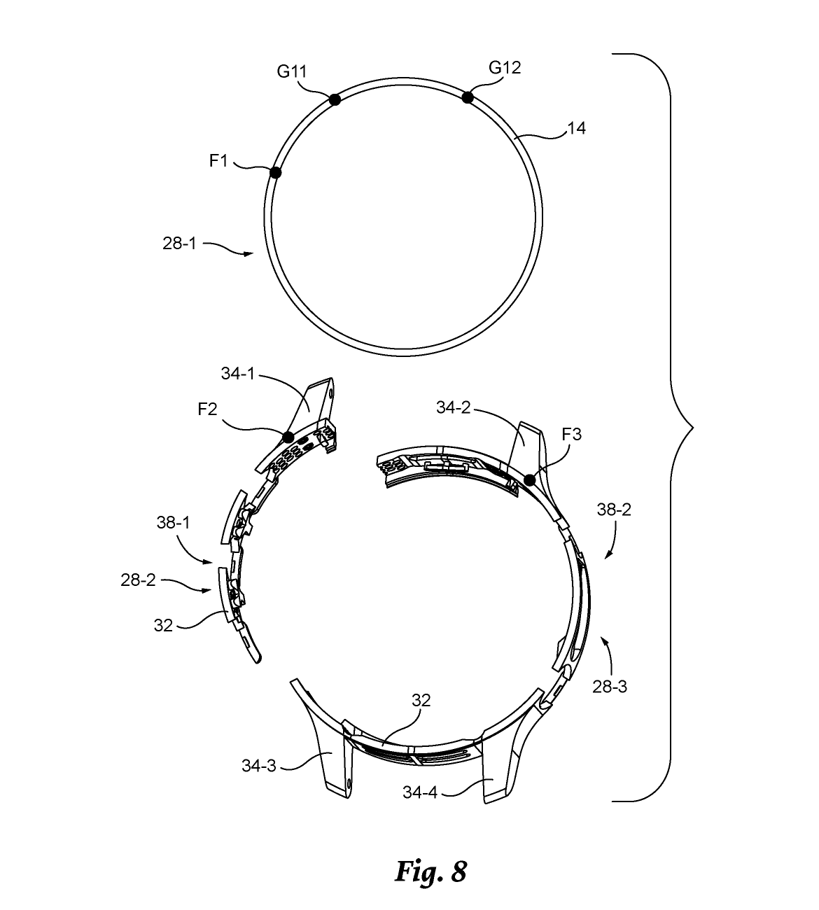

Referring to FIG. 8, in a sixth configuration or embodiment, the electronic device 10 includes the first antenna 28-1, the second antenna 28-2, and the third antenna 28-3. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock, a first ground point G11 positioned on the bezel 14 at approximately 11 o'clock, and a second ground point G12 positioned on the bezel 14 at approximately 1 o’clock.

The second antenna 28-2 is formed at least in part by, or includes, a first housing section 38-1, which includes the first lug 34-1 and a first portion of the side wall 32 extending from approximately 8 o’clock clockwise to approximately 11 o'clock. The second antenna 28-2 may also include a signal feed point F2 positioned on the upper surface of the side wall 32 at approximately 11 o’clock.

The third antenna 28-3 is formed at least in part by, or includes, a second housing section 38-2, which includes the second lug 34-2, the third lug 34-3, the fourth lug 34-4, and a second portion of the side wall 32 extending from approximately 8 o’clock counterclockwise to approximately 11 o'clock. The third antenna 28-3 may also include a signal feed point F3 positioned on the upper surface of the side wall 32 at approximately 1 o’clock.

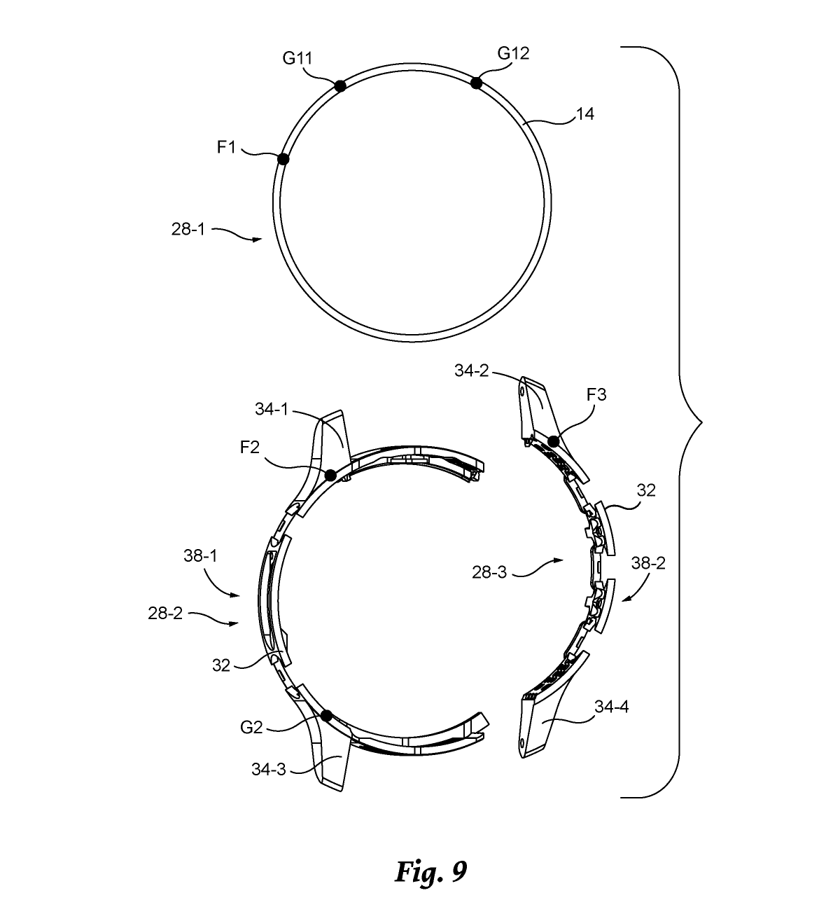

Referring to FIG. 9, in a seventh configuration or embodiment, the electronic device 10 includes the first antenna 28-1, the second antenna 28-2, and the third antenna 28-3. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock, a first ground point G11 positioned on the bezel 14 at approximately 11 o'clock, and a second ground point G12 positioned on the bezel 14 at approximately 1 o’clock.

The second antenna 28-2 is formed at least in part by, or includes, a first housing section 38-1, which includes the first lug 34-1, the third lug 34-3, and a first portion of the side wall 32 extending from approximately 5 o’clock clockwise to approximately 1 o'clock. The second antenna 28-2 may also include a signal feed point F2 positioned on the upper surface of the side wall 32 at approximately 11 o’clock. The second antenna 28-2 further includes a ground point G2 positioned on the upper surface of the side wall 32 at approximately 7 o'clock.

The third antenna 28-3 is formed at least in part by, or includes, a second housing section 38-2, which includes the second lug 34-2, the fourth lug 34-4, and a second portion of the side wall 32 extending from approximately 5 o’clock counterclockwise to approximately 1 o'clock. The third antenna 28-3 may also include a signal feed point F3 positioned on the upper surface of the side wall 32 at approximately 1 o’clock.

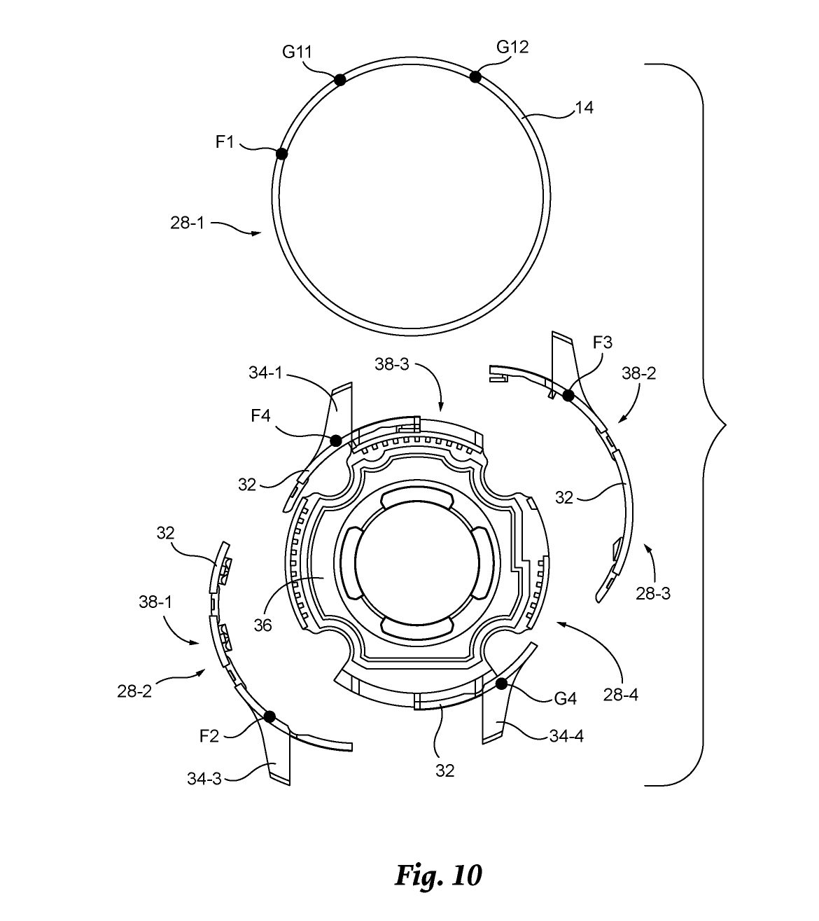

Referring to FIG. 10, in an eighth configuration or embodiment, the electronic device 10 includes the first antenna 28-1, the second antenna 28-2, the third antenna 28-3, and the fourth antenna 28-4. The first antenna 28-1 is formed at least in part by, or includes, the bezel 14. In some embodiments, the entire bezel 14 may be utilized, while in other embodiments, a portion of the circumference of the bezel 14 may be utilized. The first antenna 28-1 may also include a signal feed point F1 positioned on the bezel 14 between approximately 9 o’clock and approximately 10 o'clock, a first ground point G11 positioned on the bezel 14 at approximately 11 o'clock, and a second ground point G12 positioned on the bezel 14 at approximately 1 o’clock.

The second antenna 28-2 is formed at least in part by, or includes, a first housing section 38-1, which includes the third lug 34-3 and a first portion of the side wall 32 extending from approximately 6 o’clock clockwise to approximately 10 o'clock. The second antenna 28-2 may also include a signal feed point F2 positioned on the upper surface of the side wall 32 at approximately 7 o’clock.

The third antenna 28-3 is formed at least in part by, or includes, a second housing section 38-2, which includes the second lug 34-2 and a second portion of the side wall 32 extending from approximately 12 o’clock clockwise to approximately 4 o'clock. The third antenna 28-3 may also include a signal feed point F3 positioned on the upper surface of the side wall 32 at approximately 1 o’clock.

The fourth antenna 28-4 is formed at least in part by, or includes, a third housing section 38-3, which includes the first lug 34-1, the fourth lug 34-4, a third portion of the side wall 32 extending from approximately 10 o’clock clockwise to approximately 12 o'clock, a fourth portion of the side wall 32 extending from approximately 4 o'clock clockwise to approximately 6 o'clock, and the bottom plate 36. The fourth antenna 28-4 may also include a signal feed point F4 positioned on the upper surface of the side wall 32 at approximately 11 o’clock and a ground point G4 positioned on the upper surface of the side wall 32 at approximately 5 o’clock.

In various additional configurations, the housing 12 may be divided into at least two housing sections 38 in any of the following exemplary ways. In one configuration, the first housing section 38-1 includes the first lug 34-1, the second lug 34-2, and a first portion of the side wall 32, and the second housing section 38-2 includes the third lug 34-3, the fourth lug 34-4, a second portion of the side wall 32, and the bottom plate 36. In another configuration, the first housing section 38-1 includes the first lug 34-1 and a first portion of the side wall 32, and the second housing section 38-2 includes the second lug 34-2, the third lug 34-3, the fourth lug 34-4, a second portion of the side wall 32, and the bottom plate 36. In another configuration, the first housing section 38-1 includes the first lug 34-1 and a first portion of the side wall 32, and the second housing section 38-2 includes the second lug 34-2, the third lug 34-3, the fourth lug 34-4, and a second portion of the side wall 32. In another configuration, the first housing section 38-1 includes the first lug 34-1, the third lug 34-3, and a first portion of the side wall 32, and the second housing section 38-2 includes the second lug 34-2, the fourth lug 34-4, a second portion of the side wall 32, and the bottom plate 36. In still another configuration, the first housing section 38-1 includes the first lug 34-1, a first portion of the side wall 32, the fourth lug 34-4, a second portion of the side wall 32, and the bottom plate 36, and the second housing section 38-2 includes the second lug 34-2 and a third portion of the side wall 32.

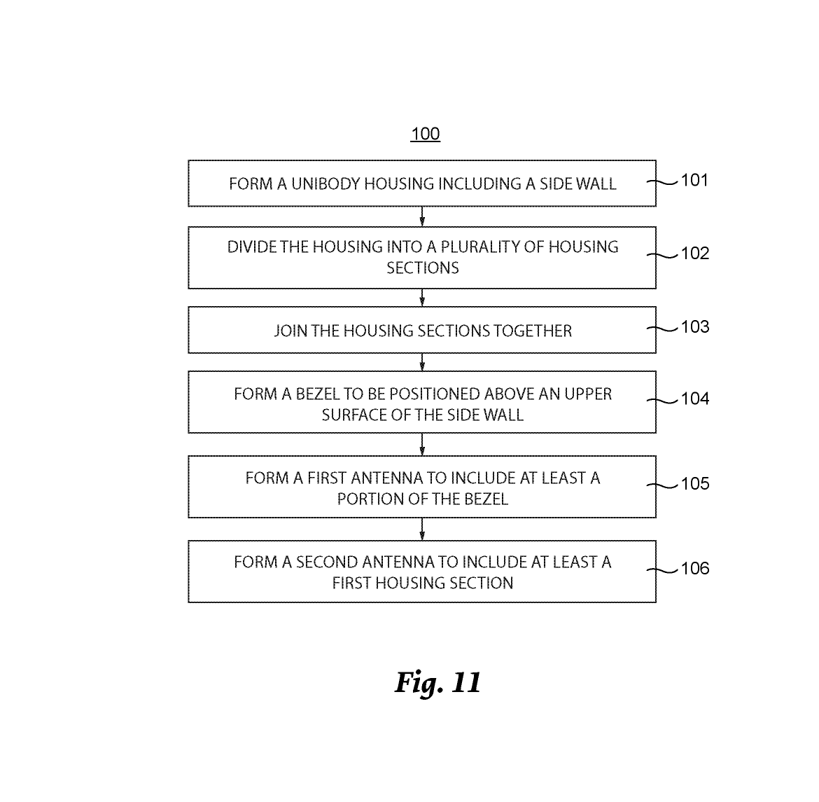

FIG. 11 depicts a listing of at least a portion of the steps of an exemplary method 100 for manufacturing a wrist-worn electronic device 10. Variations to the steps may be performed. The steps may be performed in the order shown in FIG. 11, or they may be performed in a different order. Furthermore, some steps may be performed concurrently as opposed to sequentially. In addition, some steps may be optional or may not be performed.

Referring to step 101, a unibody housing 12 is formed. The housing 12 may include at least one side wall 32, a plurality of lugs 34, and a bottom plate 36. In exemplary embodiments that are shown in the figures, the housing 12 includes a single side wall 32, with inner and outer surfaces, an upper surface or edge, and a lower surface or edge. The side wall 32 has a circular or ring shape which generally forms a hollow cylinder. The lugs 34 include a first lug 34-1, a second lug 34-2, a third lug 34-3, and a fourth lug 34-4. Each lug 34 is attached, connected, or coupled to the outer surface of the side wall 32 at a respective one of a plurality of angular positions generally related to the hourly positions on a clock face, which are positioned 30 degrees apart from one another. For example, the first lug 34-1 may be coupled to the side wall 32 at the 11 o’clock position, the second lug 34-2 may be coupled to the side wall 32 at the 1 o’clock position, the third lug 34-3 may be coupled to the side wall 32 at the 7 o’clock position, and the fourth lug 34-4 may be coupled to the side wall 32 at the 5 o’clock position. The bottom plate 36 is positioned beneath, and attached to, the lower surface of the side wall 32. The bottom plate 36 generally conforms to the shape of the side wall 32. Thus, exemplary embodiments of the bottom plate 36 have a circular or disc shape.

The housing 12 may be formed using one or more of a variety of techniques including machining, molding such as injection molding, casting, additive manufacturing such as 3D printing including laser sintering, laser melting, and so forth.

Referring to step 102, the housing 12 is divided into a plurality of housing sections 38. Each housing section 38 includes at least one of, or a combination of two or more of, the side wall 32, the first lug 34-1, the second lug 34-2, the third lug 34-3, the fourth lug 34-4, and the bottom plate 36 or portions thereof. For example, in one configuration, a first housing section 38-1 may include the first lug 34-1 and a first portion of the side wall 32, while a second housing section 38-2 may include the second lug 34-2, the third lug 34-3, the fourth lug 34-4, a second portion of the side wall 32, and the bottom plate 36. In another configuration, the first housing section 38-1 may include the first lug 34-1, the second lug 34-2, and a third portion of the side wall 32, while the second housing section 38-2 may include the third lug 34-3, the fourth lug 34-4, a fourth portion of the side wall 32, and the bottom plate 36. The housing 12 may be divided into the housing sections 38 by machining, sawing, laser beam cutting, ion beam cutting, or the like.

In some embodiments, the housing 12 is initially formed as a unibody, monolithic component and is subsequently divided into the plurality of housing sections 38. The division of the housing 12 into the housing sections 38 may be performed using one or more material-removal processes, such as machining, sawing, laser beam cutting, ion beam cutting, or similar techniques, such that each resulting housing section 38 includes a respective combination of the side wall 32, one or more of the lugs 34, and optionally the bottom plate 36 or portions thereof.

In other embodiments, the housing 12 is not initially formed as a unibody structure. Instead, each housing section 38 may be formed independently as a separate component, with each housing section 38 defining a respective combination of the side wall 32, one or more of the lugs 34, and optionally the bottom plate 36 or portions thereof. The independently formed housing sections 38 may then be joined or otherwise formed together, as described below, to collectively define the complete housing 12.

Referring to step 103, the housing sections 38 are joined together to form the complete housing 12. For example, after step 102 the housing 12 may have been divided into two (2) housing sections 38. With reference to FIG. 4, the first housing section 38-1 may include the first lug 34-1, the second lug 34-2, and a first portion of the side wall 32, and the second housing section 38-2 may include the third lug 34-3, the fourth lug 34-4, a second portion of the side wall 32, and the bottom plate 36. The first housing section 38-1 may be joined to the second housing section 38-2 by attaching the first portion of the side wall 32 to the second portion of the side wall 32 and to the bottom plate 36. The housing sections 38 may be joined to one another by applying or molding a polymer or other adhesive material (which is electrically non-conductive) to each housing section 38 along the surfaces to be joined. Continuing the previous example, the adhesive material may be applied to the lower surface of the first portion of the side wall 32 and to an upper edge surface of the bottom plate 36. The adhesive material may also be applied to the edges of the first and second portions of the side wall 32 that are to be joined together. The first portion of the side wall 32 may be joined to the second portion of the side wall 32 and to the bottom plate 36. Optionally, the assembly of the first housing section 38-1 and the second housing section 38-2 may be cured.

In addition to adhesive-based joining, the housing sections 38 may be joined together using a variety of other techniques, provided that electrical isolation between adjacent housing sections 38 is maintained where desired. By way of example, the housing sections 38 may be mechanically fastened using pins, screws, clips, or interlocking features, may be overmolded with an electrically insulating material, or may be joined using insert molding or co-molding processes. In some embodiments, combinations of mechanical attachment and electrically insulating materials may be used to provide structural integrity while preserving the electrical separation of the housing sections 38.

In some embodiments, the housing sections 38 may be formed and subsequently joined together by injecting, placing, or otherwise positioning one or more electrically isolating components within the housing 12. For example, electrically insulating inserts, barriers, or spacers may be positioned between adjacent housing sections 38, or an electrically insulating material may be injected into gaps or interfaces defined between the housing sections 38, such that the housing sections 38 are mechanically coupled while remaining electrically isolated from one another.

Referring to step 104, a bezel 14 is formed. The bezel 14 is generally annular shaped with a circular aspect and has a central opening through which the display 16 is visible and may, itself, retain a lens or other components that cover the display 16. The bezel 14 is formed from electrically conductive materials, such as metals and/or metal alloys, which are also electromagnetically radiating. The bezel 14 is positioned above the upper surface of the side wall 32. In various embodiments, the bezel 14 may be coupled to an electrically insulating ring which is coupled to the upper surface of the side wall 32, such that the bezel 14 is not electrically connected to the side wall 32.

Referring to step 105, a first antenna 28-1 is formed. The first antenna 28-1 may operate at a first frequency, which may vary according to, or depend on, a length of the radiating portion of the first antenna 28-1. The first antenna 28-1 is formed at least in part by, or includes, the bezel 14. In some embodiments, the entire bezel 14 may be utilized, while in other embodiments, a portion of the circumference of the bezel 14 may be utilized. In addition, the first antenna 28-1 may be in electronic communication with the communication element 24, the location determining element 26, or both.

Referring to step 106, a second antenna 28-2 is formed. The second antenna 28-2 may operate at a second frequency, which may vary according to, or depend on, a length of the radiating portion of the second antenna 28-2. The second antenna 28-2 is formed at least in part by, or includes, the first housing section 38-1, wherein the various compositions of the first housing section 38-1 are discussed above. In addition, the second antenna 28-2 may be in electronic communication with the communication element 24, the location determining element 26, or both.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either present technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A wrist-worn electronic device comprising:
a housing including
a circumferential side wall,
a first lug coupled to an outer surface of the side wall at a first angular position,
a second lug coupled to the outer surface of the side wall at a second angular position,
a third lug coupled to the outer surface of the side wall at a third angular position,
a fourth lug coupled to the outer surface of the side wall at a fourth angular position, and
a bottom plate coupled to a lower surface of the side wall, the bottom plate, the first, second, third, and fourth lugs, and the side wall each at least partially formed from electrically conductive material,
wherein the housing further includes a plurality of housing sections, each housing section including at least one of, or a combination of two or more of the first, second, third, and fourth lugs, the bottom plate, and the side wall or portions thereof;
a bezel positioned above an upper surface of the side wall, the bezel at least partially formed from electrically conductive material;
a first antenna configured to operate at a first frequency, the first antenna including at least a portion of the bezel; and
a second antenna configured to operate at a second frequency, the second antenna including at least a first one of the housing sections.

2. The wrist-worn electronic device of claim 1, wherein each housing section is electrically isolated from the other housing sections.

3. The wrist-worn electronic device of claim 1, wherein the first frequency includes a frequency in at least one of the global positioning system (GPS) L1 band with a center value of approximately 1575 megahertz (MHz) and the GPS L5 band with a center value of approximately 1176 MHz.

4. The wrist-worn electronic device of claim 1, wherein the second frequency includes a frequency in at least one of the long term evolution (LTE), Bluetooth™, and non-terrestrial network (NTN) bands.

5. The wrist-worn electronic device of claim 1, further comprising a third antenna configured to operate at a third frequency, the third antenna including at least a second one of the housing sections.

6. The wrist-worn electronic device of claim 5, wherein the first housing section includes the first lug, the second lug, and a first portion of the side wall, and the second housing section includes the third lug, the fourth lug, a second portion of the side wall, and the bottom plate.

7. The wrist-worn electronic device of claim 5, wherein the first housing section includes the first lug and a first portion of the side wall, and the second housing section includes the second lug, the third lug, the fourth lug, a second portion of the side wall, and the bottom plate.

8. The wrist-worn electronic device of claim 5, wherein the first housing section includes the first lug and a first portion of the side wall, and the second housing section includes the second lug, the third lug, the fourth lug, and a second portion of the side wall.

9. The wrist-worn electronic device of claim 5, wherein the first housing section includes the first lug, the third lug, and a first portion of the side wall, and the second housing section includes the second lug, the fourth lug, a second portion of the side wall, and the bottom plate.

10. The wrist-worn electronic device of claim 5, wherein the first housing section includes the first lug, a first portion of the side wall, the fourth lug, a second portion of the side wall, and the bottom plate, and the second housing section includes the second lug and a third portion of the side wall.

11. The wrist-worn electronic device of claim 5, wherein the third frequency includes a frequency in at least one of the long term evolution (LTE), Bluetooth™, and non-terrestrial network (NTN) bands.

12. The wrist-worn electronic device of claim 11, further comprising a fourth antenna configured to operate at a fourth frequency, the fourth antenna formed at least in part by a third one of the housing sections including the third lug and a third portion of the side wall.

13. A wrist-worn electronic device comprising:
a housing including
a circumferential side wall,
a first lug coupled to an outer surface of the side wall at a first angular position,
a second lug coupled to the outer surface of the side wall at a second angular position,
a third lug coupled to the outer surface of the side wall at a third angular position,
a fourth lug coupled to the outer surface of the side wall at a fourth angular position, and
a bottom plate coupled to a lower surface of the side wall, the bottom plate, the first, second, third, and fourth lugs, and the side wall each at least partially formed from electrically conductive material,
wherein the housing further includes a plurality of housing sections, each housing section including at least one combination of two or more of the first, second, third, and fourth lugs, the bottom plate, and the side wall or portions thereof, each housing section being electrically isolated from the other housing sections;
a bezel positioned above an upper surface of the side wall, the bezel at least partially formed from electrically conductive material;
a first antenna configured to operate at a first frequency, the first antenna including at least a portion of the bezel;
a second antenna configured to operate at a second frequency, the second antenna including at least a first one of the housing sections; and
a third antenna configured to operate at a third frequency, the third antenna including at least a second one of the housing sections.

14. The wrist-worn electronic device of claim 13, wherein the first frequency includes a frequency in at least one of the global positioning system (GPS) L1 band with a center value of approximately 1575 megahertz (MHz) and the GPS L5 band with a center value of approximately 1176 MHz.

15. The wrist-worn electronic device of claim 13, wherein the second frequency and the third frequency each include a frequency in at least one of the long term evolution (LTE), Bluetooth™, and non-terrestrial network (NTN) bands.

16. A method of manufacturing a wrist-worn electronic device, the method comprising:
forming a unibody housing including
a circumferential side wall,
a first lug coupled to an outer surface of the side wall at a first angular position,
a second lug coupled to the outer surface of the side wall at a second angular position,
a third lug coupled to the outer surface of the side wall at a third angular position,
a fourth lug coupled to the outer surface of the side wall at a fourth angular position, and
a bottom plate coupled to a lower surface of the side wall, the bottom plate, the first, second, third, and fourth lugs, and the side wall each at least partially formed from electrically conductive material;
dividing the housing into a plurality of housing sections, each housing section including a respective one of a plurality of combinations of two or more of the first, second, third, and fourth lugs, the bottom plate, and the side wall or portions thereof;
forming a bezel to be positioned above an upper surface of the side wall, the bezel at least partially formed from electrically conductive material;
forming a first antenna configured to operate at a first frequency, the first antenna including at least a portion of the bezel; and
forming a second antenna configured to operate at a second frequency, the second antenna including at least a first one of the housing sections.

17. The method of claim 16, wherein each housing section is electrically isolated from the other housing sections.

18. The method of claim 16, further comprising joining the housing sections together.

19. The method of claim 16, wherein the first frequency includes a frequency in at least one of the global positioning system (GPS) L1 band with a center value of approximately 1575.42 megahertz (MHz) and the GPS L5 band with a center value of approximately 1176.45 MHz, and the second frequency includes a frequency in at least one of the long term evolution (LTE), Bluetooth™, and non-terrestrial network (NTN) bands.

20. The method of claim 16, further comprising forming a third antenna configured to operate at a third frequency, the third antenna including at least a second one of the housing sections.
